(19) United States
(12) Patent Application Publication
(10) Pub. No.: US 2025/0001491 A1
(43) Pub. Date: Jan. 2, 2025

(54) HIGH-EFFICIENCY COLD CRUCIBLE AND METHOD OF MANUFACTURING THEREOF

(71) Applicants: Antonio Alessandro ROSSI, Bassano del Grappa (VI) (IT); ISTITUTO NAZIONALE DI FISICA NUCLEARE, Roma (IT)

(72) Inventors: Antonio Alessandro ROSSI, Bassano del Grappa (VI) (IT); Marco CAVENAGO, Legnaro (PD) (IT); Michele COMUNIAN, Gazzera (VE) (IT); Giorgio KEPPEL, Albignasego (PD) (IT)

(73) Assignee: ADD TO SHAPE SRL, Mussolente (VI) (IT)

(21) Appl. No.: 18/711,579

(22) PCT Filed: Sep. 21, 2022
(86) PCT No.: PCT/IB2022/058931

§ 371 Date: May 18, 2024

(30) Foreign Application Priority Data
Sep. 21, 2021 (IT) 102021000024227

(51) Int. Cl. B22D 41/01; B22D 37/00; B22F 10/28; B22F 10/80; B33Y 10/00; B33Y 50/00; B33Y 80/00

(52) U.S. Cl. CPC B22D 41/01; B22D 37/00; B22F 10/28; B22F 10/80; B33Y 10/00; B33Y 50/00; B33Y 80/00; B22F 2301/10; B22F 2998/10

(57) ABSTRACT

A cold crucible for casting metals includes:
a metal body having walls defining an internal volume inside which a material is received, the walls are divided into segments by a plurality of slits;
an induction coil wound around said body and configured so as to melt the material;
a cooling system to maintain circulation of a fluid between one or more fluid inlets and one or more fluid outlets

The cooling system includes a heat exchanger, integrated within a volume of the segments, made up of interconnected structures, fluidically connected to each other, and fluidically connected to the one or more fluid inlets and to the one or more fluid outlets so that the fluid can circulate inside the heat exchanger along one or more paths extending between the fluid inlets and the fluid outlets, with a net mass flow between the fluid inlets and outlets.

### TECHNICAL FIELD

The present invention relates to cold crucible technology for casting in vacuum or in inert atmosphere pure metals and metal alloys, including refractory alloys which require a high degree of purity.

### BACKGROUND ART

Crucibles are containers made of refractory or metal material, generally cylindrical. or frusto-conical in shape, used to melt metals or glass.

One of the melting techniques involves the use of a so-called “cold crucible” (or CC), a technology that is also identified by the acronyms ISM (“Induction Skull Melting”), CCLM (“Cold Crucible Levitation Melting”) or EMCC (“ElectroMagnetic Cold Crucible”).

Anyhow, with this technology the material is melted as the result of electromagnetic induction. In summary, a metal crucible surrounded by a conductive coil (or inductor) and cooled by water is used. The inductor carries a current of suitable frequency and intensity produced by an external generator. The crucible, generally cylindrical in shape, has slits (or “cuts”) longitudinal to the axis of revolution. Slits divide the crucible into a number of segments also called “petals” or “fingers”. Slits allow the oscillating magnetic field to penetrate the crucible. As a consequence, the time-varying magnetic field induces Eddy currents (or Foucault currents) in the metal load which heat and melt the metal due to the Joule effect. When the power of the generator exceeds a critical value, the currents induced in the metal load are so intense that the metal in the crucible is melted. In short, the melted metal is usually named “melt”.

The time-varying magnetic field inside the crucible not only induces Eddy currents in the melt, but also generates a levitating force acting on the metal load i.e., on the metal to be melted. Depending on the intensity of the levitation force, cold crucibles are grouped in families of “semi-levitation” or “complete levitation” crucibles.

The crucible, being metallic, is also subject to Eddy currents and induction heating. The crucible does not melt (hence the name of the technique) since the walls are constantly cooled with water, or other refrigerating fluids, conveyed through a system of ducts or cooling pipes. It would be desirable to have the highest number of petals (to improve interaction between electromagnetic field and metal load) and cooling pipes (to improve heat exchange), but in practice it has not been possible till now to fulfill such conflictual design requirements especially if the crucible is manufactured with standard subtractive machining.

Cold casting technology is generally used to obtain high purity cast parts (e.g., components subject to fatigue) or parts made with metals and metal alloys with high or very high melting points, or metal alloys with poor miscibility (e.g., Ti/Al alloys for aerospace applications).

Although the technology of melting metals in cold crucibles has been known and applied for several years, it has a number of drawbacks that in practice have restricted its use only to high-tech applications as well as to highly specific components and not a mass production.

The most relevant limitation of known cold crucibles concerns energy efficiency and melt handling. Such limitation derives from the complexity of applying electromagnetic simulation to practical applications in order to obtain crucibles geometries that, first, optimize the transmission of the magnetic field inside the crucible (especially near the bottom) and then, increase the energy transfer to the metal load and hence the levitating force. Integration of traditional manufacturing technologies with complex shapes that usually characterize higher efficiency crucibles represents the main technical challenge of such simulations.

In fact, conventional mechanical processing (subtractive manufacturing and molding technology) allows fabrication of crucibles having only simple shapes. This limitation especially affects the cooling channels that ideally should be integrated in each segment for an efficient heat exchange. For example, if channels are made by drilling, they necessarily must be straight and must have a diameter large enough for the insertion of a second coaxial internal pipe for the delivery of water. This widespread geometry is problematic as far as water tightness under pressure and pressure drops are concerned. Furthermore, a straight cooling pipe is not the optimal solution for heat dissipation because it cannot be distributed throughout the entire volume of the crucible segment and in addition it offers a limited heat exchange surface.

Finally, straight pipes are often used with a coaxial delivery and return system of the refrigerant fluid, a configuration highly inefficient as the cooling of the crucible petal is possible only with the ascending flow (or descending flow).

For these reasons a straight cooling pipe should ideally be replaced by a pipe with convolutions, which, however, cannot be made with conventional manufacturing processes. Straight cooling channels represent a constraint that forces the crucible to non-optimal shapes (i.e., cylindrical-like crucibles) as far as the electromagnetic energy transfer is concerned. This prevent the lower “goblet” portion from being efficiently cooled, and consequently prevent to increase the energy transfer to the bottom of the crucible.

In addition, cylindrical-like shapes are not optimal because the efficiency of levitation and induction of electric currents in the melt are severely limited. As a result, in a cylindrical geometry overheating of the crucible is obtained at the expense of the melt since a greater electromagnetic coupling is established between inductor and crucible rather than between inductor and melt. In this regard, it should be noted that additional pipes could be added into the crucible segments or pipes diameter could be increased in order to maximize cooling. However, these solutions limit transmission and distribution of electromagnetic fields inside the crucible and therefore the levitation of the melt.

To sum up, currently limitations and technological constraints described above make available only cold crucibles characterized by high energy consumption (due to poor design optimization), a simple cylindrical shape (required to accommodate straight cooling ducts) and a limited useful internal volume for melting metals (due to the considerable thickness of the petals walls required to accommodate the pipes).

Such limitations have also an impact on the geometry of the casting piece. In fact, traditional cold crucibles are scarcely versatile since their cylindric-like shape allows production of cylindrical ingots solidified inside the crucible (named “continuous casting crucibles”). Casting pieces of different shapes can only be obtained by rotating the crucible and casting the melt into a mold.

In the last years, Additive Manufacturing (AM), has become a viable technology option for producing objects of complex shapes (see for instance, Wohlers' Reports on additive manufacturing, 3D printing, and rapid product development).

The patent application CN111872389A in the name of Cao Junming discloses a 3D printing device and a method for preparing a water-cooled copper crucible.

The cold crucible obtained by the method proposed by Cao is shown in the enclosed FIG. 1. It is apparent that the application discloses a standard cold crucible where the pipe of the cooling system (“waterway pipe” referred to as 07 in FIG. 1) is mostly external to the petal (referred to as 04). This is not surprise because the object of CN111872389A is indeed a method useful to design the crucible structure so that the width of the water path at the bottom of the crucible is gradually reduced towards the center of the crucible and extends to be close to the center of the bottom of the crucible (as shown in FIG. 4).

By using this principle, named “conformal cooling”, the inventor claims that it is possible to fully cool the whole crucible. Anyhow, the disclosure of CN111872389A provides no useful teachings neither experimental evidence of this achievement.

In addition, the “water path” extends to be close to the center of the bottom of the crucible and hence it is only partially integrated within the entire volume of the petal (i.e., it is not a part of the crucible which is embedded within the entire volume of the petal). Therefore, the “conformal cooling” principle is not useful to cool the entire crucible but at best only its bottom.

Another limitation of the “conformal cooling” principle concerns the way the delivery and return pipes of the cooling circuit are positioned. As FIG. 1 clearly shows, such pipes are on the bottom of the crucible. This configuration limits handling of the melt. For instance, it is difficult to position a valve to pour the molten metal in a mold.

To sum up, although the solution proposed by Cao represents an improvement of cold crucibles manufacturing, it does not address relevant technical issues of the current cold crucible technology: first, how to improve cooling efficiency of a cold crucible and then, how to reduce energy consumption of a melting process performed by means of cold crucible technology.

Particularly, the description provided does not disclose any useful teaching that those skilled in the art would use to design a cold crucible having a structure of the heat exchanger different (i.e., not based on cylindric-like pipes) and more efficient than the one shown in FIG. 1 and particularly having waterway pipes fully integrated or embedded with the petals.

It should be noted that the use of AM techniques for producing metal components with high thermal and electrical conductivity, suitable to manage gases and liquids under pressure, still represents a technical challenge. As a matter of fact, cold crucibles having a structure of the heat exchange system more complex than the simple one disclosed in CN111872389A are not available yet on the market.

According to the best knowledge of the present inventors, no other publications are known where teachings to overcome or mitigate limitations of traditional cold crucibles are available. For this reason, CN111872389A can be regarded as the closest prior art of the present invention.

Recently, AM technology has made possible to produce objects with very complex structures such as e.g., a gyroid, catenoids, helicoids, Schwarz surfaces (P, D, H, CLP) and Neovius surfaces.

Gyroid structures are the geometric expression of a surface defined as “minimal”. A surface is defined as minimum when the area defined by its contour is the minimum possible surface (mathematically it means that the curvature at each point of the surface is zero, i.e., the second derivative is zero). Furthermore, gyroids structures are very attractive for AM process as they are by nature self-supporting and do not require scaffolds structures to guarantee that the intended shape is maintained during printing process.

Practical usage of gyroid-like structures produced via AM have been proposed only recently. For instance, in “FEW0225: High-efficiency, integrated reactors for sorbents, solvents, and membranes using additive manufacturing”, presented by Joshuah K. Stolaroff at NETL Carbon Capture Technology Program Review, Aug. 13, 2018, the potentials of gyroid reactors fabricated by AM to improve heat and mass transfer are reviewed. Anyhow, this work is focused on reactors technology issues and it is of no use for those skilled in the art wishing to improve cold crucibles

In conclusion, according to the best knowledge of the present inventors, it is not adequately addressed energy consumption and melt handling in cold crucibles and therefore it is still possible and urgent to improve the structure of a cold crucible and a manufacturing process thereof.

### DISCLOSURE OF INVENTION

### Object/Scope of the Invention

In view of the above, the present invention intends to overcome the existing disadvantages and drawbacks of the prior art by providing a novel cold crucible useful for casting, in vacuum or inert atmosphere, pure metals and metal alloys including refractory alloys which require a high degree of purity.

Therefore, the first and main object of the present invention is to provide an electromagnetic optimized design for a cold crucible. In particular, said object includes the disclosure of a crucible design which, compared to known solutions, optimizes the transfer efficiency of electromagnetic energy to the melt and the heat exchange required to maintain the crucible in a cold state in order to increase levitation force on the melt, improve melt handling and lower power consumption at the same time.

A second important object of the present invention is to provide a cold crucible which, compared to known cold crucibles, has a higher melting capacity in terms of metal mass to be melted at the same power consumption.

A third important object of the present invention is to provide a cold crucible which prevents contamination of the melt so as to obtain extremely high purity castings. Particularly, said object includes providing a cold crucible that it is not made of ceramic materials.

A fourth important object of the present invention is to provide a cold crucible which requires low maintenance.

A fifth important object of the present invention is to provide a casting process which, by means of the cold crucible according to the present invention, is useful to obtain cast parts, even with complex geometry, having extremely higher purity compared to those obtained by means of known casting technologies.

Finally, a last object of the present invention is to provide a cold crucible and processes thereof which can be made or implemented in a simple and economical way using known technologies.

Additional objects and advantages of the invention will be set forth in part in the detailed description which follows and in part will be obvious from the description or may be learned by practice of the invention.

### Technical Solution and Inventive Concept

These and still other purposes, which will appear more clearly in the specification which follows, are achieved by a cold crucible, a process for manufacturing said crucible, a process for handling the melt as well as process for melting metals and metal alloys by means of said crucible. The invention is defined by the appended independent claims 1, 18, 20 and 21 while advantageous features are set forth in the appended dependent claims. The aforesaid claims, to which reference should be made for the sake of brevity, are hereinafter specifically defined and are intended as an integral part of the present description.

In summary, the inventive concept underlying the present invention is related to a structure and geometry of a cold crucible which optimizes conflicting design parameters in order to: first, increase the transfer efficiency of electromagnetic energy to the metal load/melt, second, ensure proper heat exchange to keep the crucible cold and then control removal of the melt from the bottom of the crucible without the aid of a discharge cap.

The inventive concept is applied to a cold crucible for melting metals and metal alloys, including refractory alloys, which is characterized by a novel “distributed” cooling system consisting of a heat exchanger fully integrated or embedded within the individual petals (hereinafter referred also as “crucible segments” or “segments”) of the goblet-like crucible body. Particularly, said heat exchanger consists of a plurality of structures which are fluidically interconnected to each other and are fluidically connected to the cooling circuit and the circulator pump of the cooling system by means of one or more fluid inlets and fluid outlets.

In other words, the heat exchanger can be considered as a periodic or non-periodic fluidic connection of interconnected elementary units (e.g., a straight or curved pipe or a gyroid) which are distributed throughout the volume of the segments and in one embodiment substantially occupy the entire volume of the segments. In this way, the fluidically interconnected structures form a network of paths (hereinafter also referred also as “percolation paths”) for the coolant fluid which can circulate inside the heat exchanger along one or more paths which extend between the fluid inlets and fluid outlets.

With standard working parameter of the circulator pump, a net mass flow between the fluid inlets and the fluid outlets, is measured (e.g., with a standard flow-meter or pressure gauge) so that in steady conditions the crucible is maintained cold during the entire melting process. The novel “distributed cooling system” ensures an increased heat exchange as the entire network of paths exchanges heat with the segments (in known type cold crucibles this was not possible due to the geometric restrictions imposed by the straight exchange pipes).

At the same time, this structure has the advantage of uncouple the cooling system from the segments geometry giving more freedom to the designer. In other words, the internal and external radial profiles of the crucible according to the present invention can follow the shapes of the segments optimized by electromagnetic simulations.

In this way, by means of the distributed cooling system it is possible to impart the crucible shapes that are more transparent to electromagnetic radiation. Preferably, the shape is similar to a goblet. Respect to known solutions (e.g., CN111872389A) having the same goblet-like shape, the crucible according to present invention has remarkable features that could not be achieved with known cold crucibles (also goblet-like crucibles): first, it is possible to design a crucible more transparent to electromagnetic radiation by increasing the number of slits; second, segments with very thin walls can be used; and finally the manifold of the cooling system can be positioned on the upper portion of the crucible.

This configuration provides space in the lower portion (in known crucible like CN111872389A that space is occupied by water manifold) and thus allows the inductor to be positioned closer to the bottom of the goblet (with an improved energy transfer and levitation force) as well as the insertion of a discharge nozzle (with an improved melt handling).

The interconnected units in the heat exchanger and the shaped slits make the geometry of the crucible according to the present invention so complex from the topological point of view that the heat exchanger can only be made by means of Additive Manufacturing (AM) techniques, preferably Selective Laser Melting (SLM).

Finally, the innovative shape of the crucible also led to the definition of a new shape for the inductor which is wound in coils around the external surface of the crucible. In particular, the inductor has not the traditional circular section but it is characterized by an asymmetric section rounded on the outer part and flat on the inner part facing the crucible. Advantageously, the inductor is made of a metal with high electrical and thermal conductivity and preferably it is made, together with the crucible, by means of AM technology. Alternatively, the inductor is made as a separate part from the crucible by AM or by traditional manufacturing techniques. The innovative effect of the crucible briefly described herein, result in a remarkable increase of the magnetic field acting on the melt and therefore in the levitating force (by more than 3 times) compared to a known type crucible having equal capacity and power consumption.

In turn, the increase in the levitation of the melt leads to an increase in the purity of the melt product and a reduction in melting costs.

### BRIEF DESCRIPTION OF DRAWINGS

The present invention will be more fully understood by reference to the following drawings which are provided solely for illustration of the embodiments and not limitation thereof:

FIG. 1, with reference to the first embodiment of the present invention, illustrates, (a) a lateral view of the crucible, (b) an axial vertical section, (c) a view from the top and (d), a horizontal section, substantially at half the height, of the lower portion of the crucible.

FIG. 2 is a detail of the horizontal section of the crucible of FIG. 1 which shows how the cooling system branches out within a single segment in delivery and return pipes;

FIG. 3, with reference to the second embodiment of the present invention, shows (a), a side view of the crucible, (b), a view of the horizontal section of the crucible and (c), a detail of the view from below showing the delivery pipes and the return pipes of the cooling system;

FIG. 4 illustrates the crucible in the third embodiment of the present invention, with evidence of the electromagnetic valve to facilitate melt handling.

FIG. 5 with reference to the second embodiment of the present invention, shows three different sections of the crucible with a focus on the arrangement of the faces of the slits (parallel, converging and parallel-rotated);

FIG. 6 illustrates the development on a 2d plane of the 3d cylindrical surface of the crucible with evidence of the slits expressed as functions of the distance along the rotation axis Z of the crucible and of the rotation angle θ of a radius perpendicular to said axis.

FIG. 7 illustrates the inductor of the crucible according to the present invention with evidence of the asymmetrical section.

FIG. 8 illustrates the structure of the cooling system and the heat exchanger of the crucible according to the preferred embodiment of the present invention;

FIG. 9 illustrates the structure of the heat exchanger of the crucible according to the fourth embodiment of the present invention. Particularly, in (a) a gyroid (left) and a Schwarz-P structure (right) are shown, while in (b) a detail of the fluidic connection between the incoming and outcoming domains is shown;

FIG. 10 shows the crucible according to the fourth embodiment of the present invention, in (a) a lateral perspective view, (b) a bottom perspective view and (c) a detail perspective view of part of the heat exchanger embedded within the segments with evidence of the gyroid-like structures.

FIG. 11 illustrates a section of the gyroid-like structures of the heat exchanger shown in FIG. 10.

These figures illustrate and demonstrate various features and embodiments of the present invention but are not to be construed as limiting the invention.

### DETAILED DESCRIPTION OF THE INVENTION

The components of said crucible are described in the following.

### Crucible Structure

A first object of the present invention is a cold crucible for melting metals having the characteristics defined in the appended claim 1 omitted here for the sake of brevity, but which is intended as an integral part of the present specification.

With reference to the aforementioned figures, said crucible is indicated with the number (1) and includes a slotted body (10), having circular symmetry around an axis, around which an inductor (30) is wound. Preferably, said slotted body has the shape of a goblet.

The body (10) has walls (16) which define an internal volume (106), substantially limited by a concave surface, which receives the material (40) to be melted.

For the sake of clarity in the description, the body (10) can be divided into an upper portion (11), a median portion (12) and a lower portion (13) contiguous to each other.

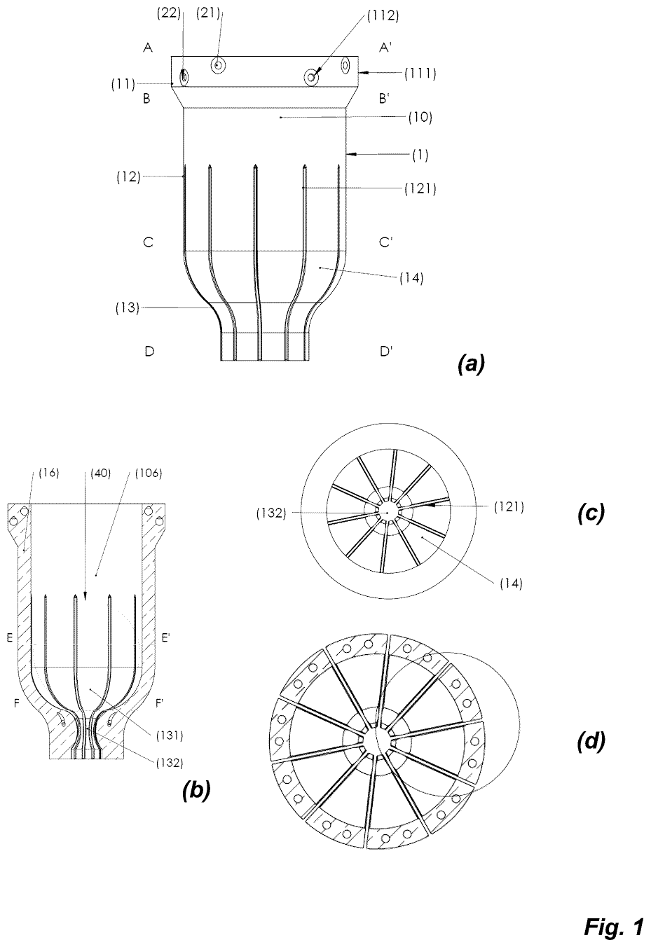

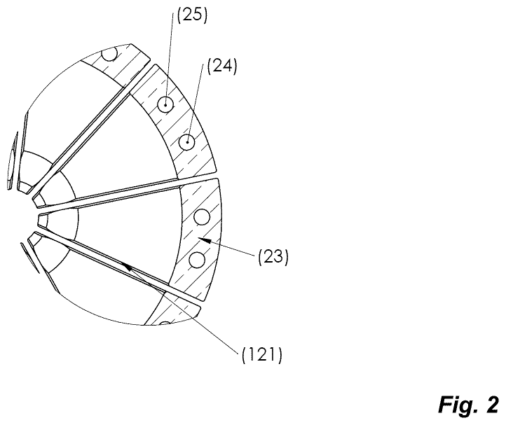

Said portions are bounded by the planes A-A′/B-B′, B-B′/C-C′, C-C′/D-D′, respectively, as shown in FIG. 1(a).

The upper portion (11) is substantially constituted by a manifold (111) having a truncated cone shape which is bounded on the top by a horizontal opening (112) in correspondence of the plane A-A′. Said manifold (111) includes one or more internal annular fluid inlets (21) and one or more internal annular fluid outlets (22) of the cooling system (20). The pipes (21,22) are connected, on the one hand, to a heat exchanger (23) and, on the other, to a conventional cooling circuit (not shown) which includes a pump for circulation of the cooling fluid, which is preferably water.

The heat exchanger (23) has an innovative structure which will be described in detail below. In a preferred embodiment, the manifold (111) consists of a first internal annular duct having four fluid inlets (21) arranged at 90° from each other, and a second internal annular duct having four fluid outlets (22) arranged at 90°. However, other arrangements with a different number of fluid inlets/outlets are possible depending on the size of the crucible (1).

The median portion (12) of the body (10) of the crucible (1), connected to the manifold (111) at the top, has a cylindrical shape which is characterized by a plurality of equally spaced slits (121) which cross the entire thickness of the walls (16) of the body (10). Like known cold crucible, the slits (121) allow transmission of electromagnetic radiation. As it will be described in detail in the following, said slits (121) are designed and arranged in way that increases melting efficiency and levitation of the molten metal.

In one embodiment, the slits (121) extend vertically for about half the height of the median portion (12) limited by the planes B-B ‘and C-C’. Below the plane C-C the slits (121) extend continuously toward the lower portion (13) of the crucible body (10), which will be described in detail below.

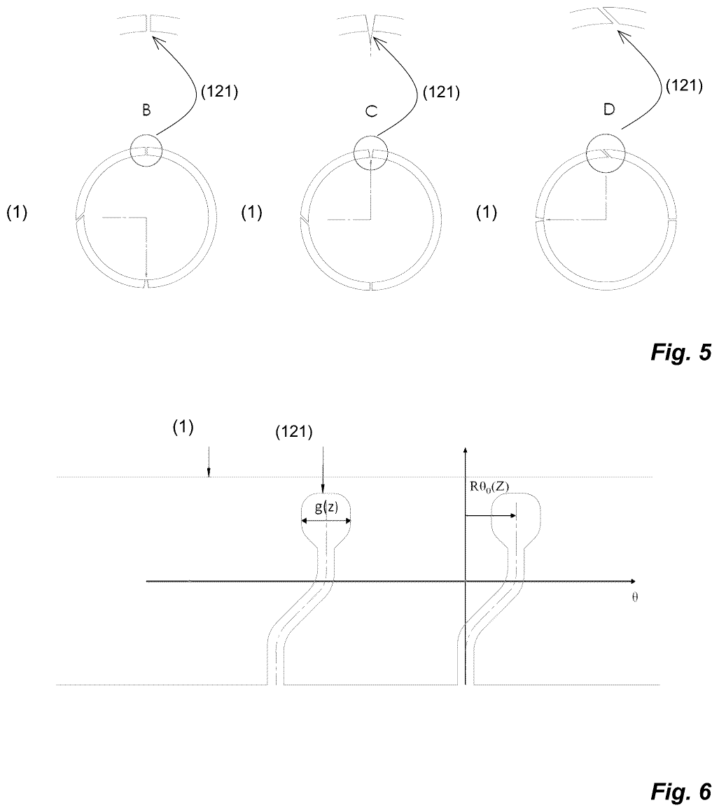

The plurality of slits (121) divides the body (10) of the crucible (1) into a plurality of segments (14). For the purposes of the present invention, the presence of at least one slit (121) is sufficient, although a greater number is preferable according to the size of the crucible (1). Preferably, the number of slits is not less than 10. As the enclosed FIG. 5 depicts, by way of explanation of the invention, and not meant as a limitation thereof, the slits cut the walls (16) of the crucible body (10) so as to present parallel faces (FIG. 5B), converging faces (FIG. 5C) or rotated-parallel faces (Figure SD).

The slit (121) width and shape can be expressed by two functions, respectively, g(z,θ) and f(z,θ)=R(z)×θₒ(z,θ), where R(z) is the radius at a distance z along the symmetry axis Z of crucible and θₒ(z,θ) is the angle corresponding to a distance z and an angle θ formed by a generic radius perpendicular to said axis Z. FIG. 6 shows the development on a plane of the 3d cylindrical surface of the crucible by means of the functions g(z,θ) and R(z)×θₒ(z,θ). The shape of the slit (121) along Z is repeated N times for discrete values of 0 as many as the number of segments (14) of the body (10).

The slots (121) can be straight or curved and all have the same or different thickness. For example, the widening of the slit (121) in the upper portion (11) of the body (10) reduces the electromagnetic field in the proximity of the manifold (111) and hence overheating of the upper portion (11) of the crucible (1).

In one embodiment g(z,θ) and θₒ(z,θ) are constant, so that the slits (121) are lines of constant thickness lying on planes perpendicular to the planes A-A′, B-B′, C-C′, D-D′. The body (10) of the crucible is divided into a plurality of straight and parallel segments (14) all identical to each other. Preferably, the crucible (1) includes 10 slits (121) which divide the body (10) into 10 segments (14) held at the top by the upper portion (11) and partly by the median portion (12) of the body (10).

In further embodiments the functions g(z,θ) and θₒ(z,θ) are not constant e.g., the slits (121) are curves of variable thickness wrapped around the body (10) so that the body (10) is divided into a plurality of twisted segments (14) as the enclosed FIG. 6 schematically illustrates. Preferably, the crucible (1) includes 10 slits (121).

As will appear more clearly in the following, the number, shape and arrangement of the slits (121) as well as the conformation of the segments (15) represent key-factors for the purposes of implementing the present invention, and have been defined by means of a non-trivial inventive activity which involved, among other things, development of an innovative calculation and simulation procedure.

Finally, the body (10) of the crucible (1) according to the present invention includes a lower portion (13) which is delimited by planes C-C′ and D-D′ and together with the slits (121) is continuously connected to the median portion (13). As shown in the enclosed FIG. 1(b) by way of explanation of the invention, and not limitation thereof, said lower portion (13) has a bottle-neck shape which defines an inner concave region (131) where a nozzle (132) is positioned on the bottom.

In one embodiment, the ratio of between the inner area corresponding to the E-E′ and F-F′ planes (FIG. 1b) is at least 4:1. In fact, with this configuration an amplification ratio of the axial magnetic field of about 3 can be achieved in the lower portion (13) of the body (10) on the basis of simulations. The amplification ensures a considerable levitation force on the melting metal which is completely satisfactory in most applications.

The crucible (1) according to the present invention includes a cooling system (20) comprising a heat exchanger (23) which is characterized by an innovative structure consisting of a periodic or non-periodic plurality of fluidically interconnected elementary structures (231) or units forming a network of paths (232) distributed throughout the entire volume of the segments (14). Within each segment (14) the network of paths (232) is divided into one or more delivery pipes (24) and one or more return pipes (25) of the cooling system.

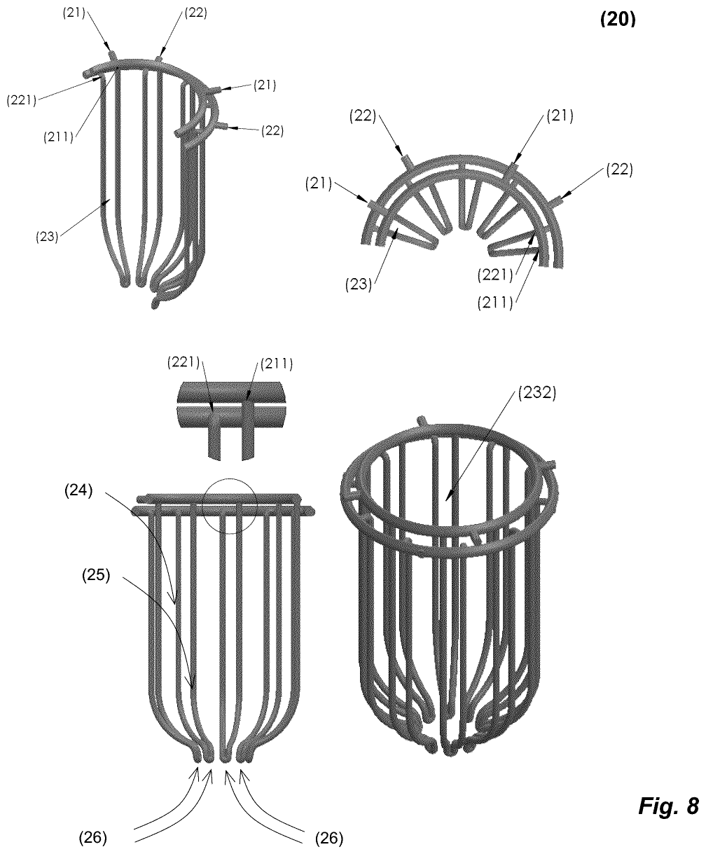

In turn, the heat exchanger (23) is fluidically connected to a recirculation pump (not shown) by means of a circuit formed by fluid inlets (21) and fluid outlets (22) placed in the manifold (111). With reference to the enclosed FIG. 8 the fluid inlets (21) enter into a segment (14) of the body (10) by means of a segment inlet (211) and similarly, the fluid outlet (22) exit out of a segment (14) by means of a segment outlet (221).

In the present specification the term “pipe” shall mean a duct for transporting a fluid and shall not be limited to pipes of circular section or constant section.

The paths (232) are represented on the basis of interconnected elementary units (231) which can be curvilinear tubular ducts of various sections, or geometrically more complex interconnected structures such as gyroids or double domains structures.

In a preferred embodiment the elementary unit is a curved or straight pipe with constant section so that the plurality of interconnected structures (231) forms a number of interconnected straight or curvilinear pipes which follow the curvature of the goblet-like crucible body (10) like those shown in the enclosed FIG. 8. The number of pipes can be may be equal, or different, to the number of segments (14).

In another embodiment the elementary unit is a curved or straight pipe of variable section so that the plurality of interconnected structures (231) forms a number of interconnected curvilinear pipes which follow the curvature of the goblet-like crucible body. The number of pipes can be may be equal, or different, to the number of segments (14).

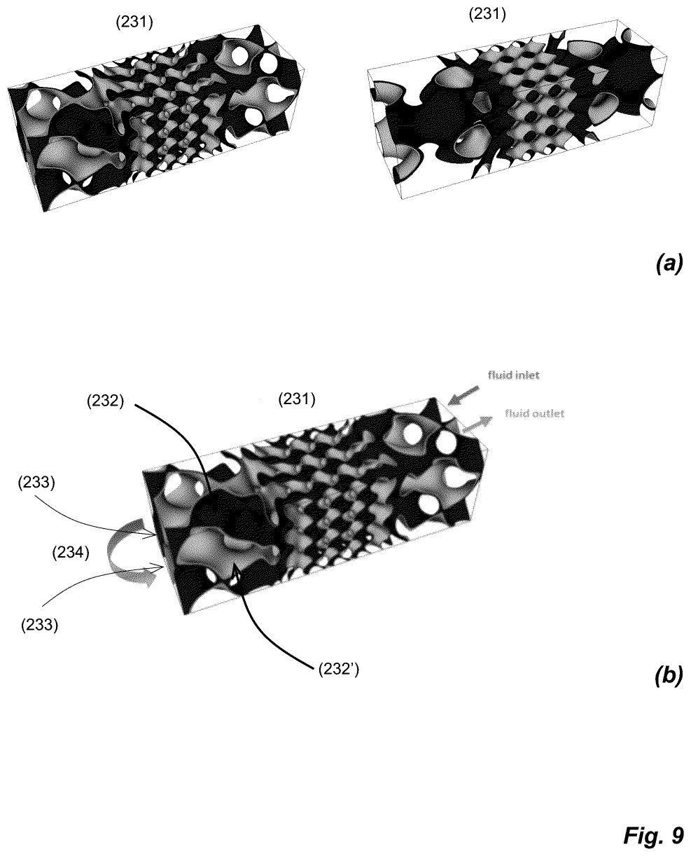

In a further embodiment the elementary unit is a gyroid or a Schwarz-P structure, such as those illustrated by way of non-limiting example in the enclosed FIG. 9a. In said embodiment, the plurality of interconnected structures (231) occupies the entire volume of the segments (14).

In an alternative embodiment, the elementary unit (231) forming the heat exchanger (23) is a catenoid, helicoid, a Neovius surface, a double domain sponge-like structure, or other minimal surface structures.

According to the present invention, the cooling fluid, preferably water, is introduced by the recirculation pump into the fluid inlets (21) positioned in the manifold (111), then passes through the segment inlet (211) and it is distributed in the individual segments (14) along one or more paths (24,25,232) and exits out of the segments (14) through the segment outlet (221) which finally flow into the fluid outlets (22).

More details on the fluidic circuit shall be provided with reference to preferred embodiments. Anyhow, using circulation pumps and standard pressure levels it is possible to obtain a net mass flow of coolant through the heat exchanger (23).

Finally, the crucible (1) according to the present invention includes an inductor (30) which is wound in several turns around the length and development of the body (10).

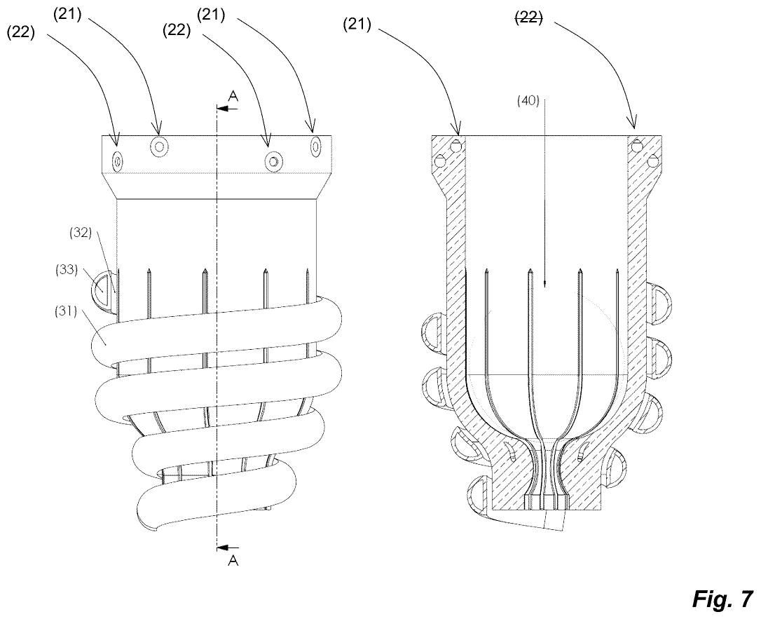

As the unit FIG. 7 schematically shows, the inductor (30) is shaped on the body (10) of the crucible. Particularly, it has a section (33) having a rounded external surface (31) and a substantially flat internal surface (32) facing the body (10). This shape has been specially designed to position the inductor (30) closer to the goblet-like body (10) and the discharge nozzle (132). This design ensures maximum transfer of electromagnetic energy to the metal (40) and therefore levitation force acting on the melt (40).

### Manufacturing Process of the Crucible

From the description provided, it will be evident to those skilled in the art that the crucible structure has a topologically complex shape that cannot be produced by means of the standard subtractive manufacturing or mold casting techniques.

The elements of complexity concern, first of all, the crucible segments (14). They have a calyx tapering with slits enveloped along the Z axis and walls (16) of low thickness. A further complexity element is, as mentioned before, the heat exchanger (23) of the cooling system (20) which consists of a plurality of interconnected elementary structures (231), for example curved pipes or gyroids, embedded in the segments (14).

Consequently, a second object of the present invention is a novel Additive Manufacturing (AM) process for manufacturing the cold crucible (1) described above.

The mean steps of said process are defined by the appended claim 16, omitted here for the sake of brevity, but which is intended as an integral part of the present specification.

In one embodiment, the AM technology used is Selective Laser Melting (SLM) and the metal used is pure copper in form of powder. The powdered copper has a purity higher than 99.99% and has a particle size between 5 and 45 μm. Preferably powder consists of spherical particles. SLM equipment and copper in powder form useful for this purpose are commercially available and well known to those skilled in the art.

In alternative embodiments, different AM techniques are used, such as Direct Metal Laser Sintering (DMLS) or Binder Jetting (BJ) technology provided that the crucible can be made from pure copper powder.

In further embodiments of the present invention, the crucible (1) is made from materials in the form of powder other than copper, such as silver, gold, platinum and their metal alloys, including refractory alloys, provided they have high electrical conductivity, preferably higher than 50% according to standards of the International Annealed Copper Standard (IACS). Mixtures of powders having different chemical compositions and/or granulometry can also be usefully employed.

In any case, the process for making the crucible (1) by means of Additive Manufacturing includes the following three steps.

### a) Crucible Model Design.

The method according to the invention starts with the definition of a crucible model (1) based on the features of the casting to be produced and particularly on the metal composition of the casting. This step involves selection of the suitable metal for the crucible, definition of the shape and size of the crucible. The step is assisted by computer simulations which provide the most suitable shape and size that make possible efficient levitation and manipulation of the selected metal and metal alloy to be casted.

Once the geometry of the crucible has been made, design of the model covers identification of the cooling system (20) which ensures the maximum possible heat exchange. Gyroid structures (231) of the heat exchanger (23) are designed by means of known parametric CAD software. Optimization of heat exchange inside the segments (14) can be obtained by varying selected parameters within a range of values. Possible choices of the parameters are, for example: the density of the gyroids, the thickness of the walls gyroids (and therefore the volume to internal surface ratio), the load values of the refrigerant fluid, rigidity and resistance of the heat exchanger (23).

The step ends with the generation of a software model, e.g., a stl file of the crucible model.

### b) Selection and Preparation of the AM Equipment.

According to choices made in the previous step. the most suitable AM technology is selected. In this stage it is necessary to prepare the AM machine, preferably a SLM machine. The preparation involves the following operations: loading the model file generated in step a); loading the metal powder, preferably pure copper, into the AM machine; generating the printing program for definition of the printing parameters and the positioning of the crucible supports to be used on the printing platform.

### c) Manufacturing and Finishing of the Crucible.

In this step the crucible (1) is made using the AM equipment selected in step b). At the end of printing stage, the crucible (1) is subjected to a heat treatment in a vacuum furnace to release internal tensions. At the end of the treatment, the supports are removed and the crucible (1) is extracted from the printing platform. The process according to the present invention ends with surface finishing of the crucible (1) in order to lower the roughness RA by means of techniques well-known to those skilled in the art. Preferably, RA is less than 1.

With the process herein disclosed it is possible to produce by means of SLM technology, a cold crucible having a useful volume even equal to 3 liters. The crucible (1) allows for casting, in vacuum or in inert atmosphere, metal alloys including refractory alloys, with a mass of 0.5 kg or more, with a purity greater than 99.99%.

Taking advantage of the high intrinsic resolution of the SLM and DMLS technology (which allows to obtain details much more minute than traditional subtractive manufacturing technologies) the crucible (1) can be easily rescaled to its linear dimensions, for castings small quantities (≤0.050 kg) of metals.

### Preferred Embodiments

Further characteristics and advantages of the invention will become apparent from the description of four preferred but not exclusive embodiments thereof.

### Preferred Embodiment: Heat Exchanger Composed of Straight and Curved Pipes

The first preferred embodiment provided by way of explanation of the invention, and not meant as a limitation thereof, refers to a crucible (1) having a structure with straight and parallel segments (14) like the one shown in the unit FIG. 1.

In particular, the crucible body (10) includes 10 segments (14), a capacity equal to 1 liter and walls (16) with a thickness between 5 and 8 mm, less than 20% of the larger diameter of the body (10). The crucible was entirely made by SLM AM technology using copper powder with IACS conductivity in a range between 98 and 100%.

In said preferred embodiment the crucible (1) includes a distributed heat exchanger (23) embedded in each segment (14) made of a plurality of elementary units in the form of a curved or straight pipes with constant section.

As shown by the enclosed FIG. 8 in the preferred embodiment, the heat exchanger (14) includes a network of paths (232) which is divided into one or more delivery pipes (24), and one or more return pipes (25). Said pipes (24,25) consist of curvilinear and straight tubular pipes made by continuously connecting elementary units (231) in the form of curved or straight tubular units of various sections. Furthermore, said delivery and return pipes (24,25) are fluidically connected by connecting pipes (26).

In the preferred embodiment, the delivery pipes (24) and the return pipes (25) are each in number of 10 for a total of 20 pipes.

The use of AF technology to produce connected curved and straight pipes and form a cooling circuit is straightforward for those skilled in the art.

To sum up, the circuit the cooling fluid can flow from top of the body (10) to bottom through straight delivery pipes (24), then flow through curved connecting pipes (26) and finally rise from the bottom of the body (10) to the top through straight return pipes (25).

In this way, the fluid incoming from the cooling circuit can flow from the top of the body (10) to the bottom through straight delivery pipes (24), then flow through curved connecting pipes (26) and rise from the bottom of the body (10) to the top through straight return pipes (25) and finally outcomes to the cooling circuit.

Although in the preferred embodiment the heat exchanger (23) is composed by a plurality of pipe elements with constant section, like e.g., CN111872389A, the structure is completely different from the ones already described in the prior art. The pipe elements are fully integrated or embedded within the crucible segments (14) i.e., they are embedded within the segments and are produced by AM technology.

With this structure of heat exchanger (23) embedded with the segments (14), the present inventors (23) experimentally verified an effective heat exchange despite the limited thickness of the walls (16). In fact, the crucible did not melt nor be damaged after more than hundreds melting cycles.

In the preferred embodiment the crucible (1) includes an inductor (30) having an asymmetric section like the one shown in FIG. 7.

The inductor (30) is specially designed, simulated to maximize energy transfer to the melt.

In the preferred embodiment the inductor (30) is manufactured by SLM Additive Manufacturing together with the body (10), and not as a separate component.

The energy required for the melting process is provided by a medium frequency induction generator and transmitted to the melt through the inductor (30).

This crucible according to the preferred embodiment of the present invention has an electromagnetic and thermal efficiency that is even 3 times higher than conventional crucibles with the same capacity. The inventors demonstrated that the crucible of the preferred embodiment is suitable for melting or casting in vacuum (or in an inert atmosphere) pure metals and metal alloys, also refractory alloys, with a high degree of purity.

In particular, it has been experimentally demonstrated that it is possible to melt 0.15 kg of niobium (Tₘ=2477° C.) in less than 120 seconds. Traditional cold crucibles with the same capacity, requires 50% to 100% more energy. The effective energy consumption agrees with the value that was previously estimated by the electromagnetic simulations of the crucible.

As the entire network of paths (232) exchanges heat within the segments (14), the cooling system (20) according to the present invention is totally different from the one proposed by Cao in CN111872389A.

### Second Embodiment: Tilted Segments

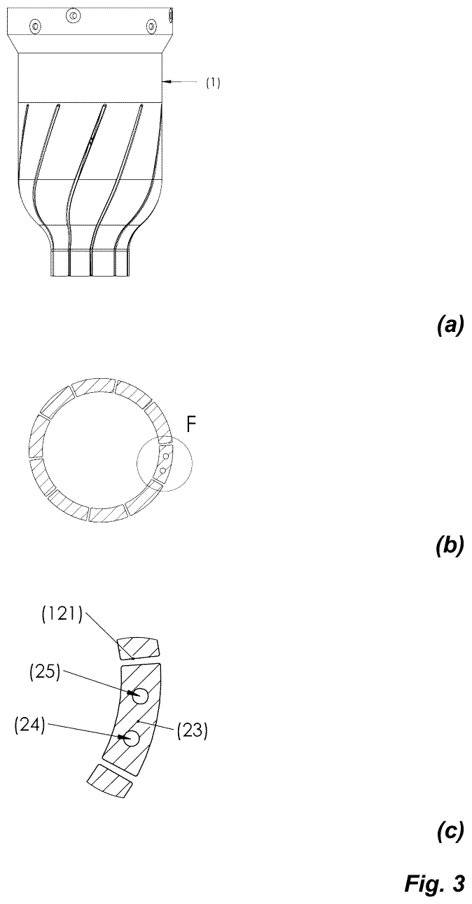

With reference to the enclosed FIG. 3, the second embodiment provided by way of explanation of the invention, and not meant as a limitation thereof, refers to a crucible (1) having a structure with tilted segments.

In this embodiment, the crucible has still 10 petals, a capacity of 1 liter and was entirely made by SLM AM using copper with IACS conductivity in a range between 98 and 100%.

From the experimental point of view, it achieves performances which are entirely similar to the crucible of the preferred embodiment. However, slits bending with respect to the radial direction greatly reduces the emission of vapors from the melt and allows a better confinement of the infrared radiation emitted by the melt (40). In turn, this results in a further reduction of energy consumption, melting times and a reduction of the metal evaporate from the melt to the chamber containing the crucible.

### Third Embodiment: Electromagnetic Valve

The third embodiment provided by way of explanation of the invention, and not meant as a limitation thereof, refers to a crucible (1) having straight and parallel segments like the one of the first embodiment.

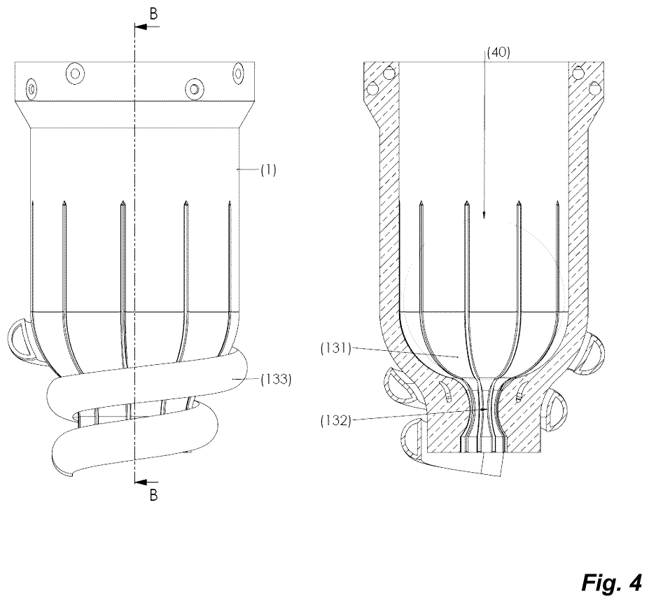

In this embodiment, the crucible (1) includes additionally an electromagnetic valve positioned near the pouring nozzle (132) on the bottom of the concave region (131) as the enclosed FIG. 4 illustrates by way of explanation of the invention and not meant as a limitation thereof.

In practice, the electromagnetic valve comprises a second inductor (133) whose power modulation allows to control the flow of liquid metal (40) when the user decides to pour the melt into a mold.

### Fourth Embodiment: Heat Exchanger Composed of Gyroid Structure

The fourth embodiment provided by way of explanation of the invention, and not meant as a limitation thereof, refers to a crucible (1) externally similar to the one of the preferred embodiment. The crucible body (10) includes 10 straight and parallel segments (14), a capacity equal to 1 liter and walls (16) with a thickness between 5 and 8 mm, less than 20% of the larger diameter of the body (10). The crucible was entirely made by SLM AM technology using copper powder with IACS conductivity in a range between 98 and 100%.

In said embodiment the crucible (1) includes a distributed heat exchanger (23) embedded in each segment (14) made of a plurality of gyroids illustrated by way of non-limiting example in the enclosed FIG. 9a (left). The surface is defined by a parametric equation having e.g., the following form (L and t are constants):

$$sin ( \frac{2 π}{L} x ) cos ( \frac{2 π}{L} y ) + sin ( \frac{2 π}{L} y ) cos ( \frac{2 π}{L} z ) + sin ( \frac{2 π}{L} z ) cos ( \frac{2 π}{L} x ) = t$$

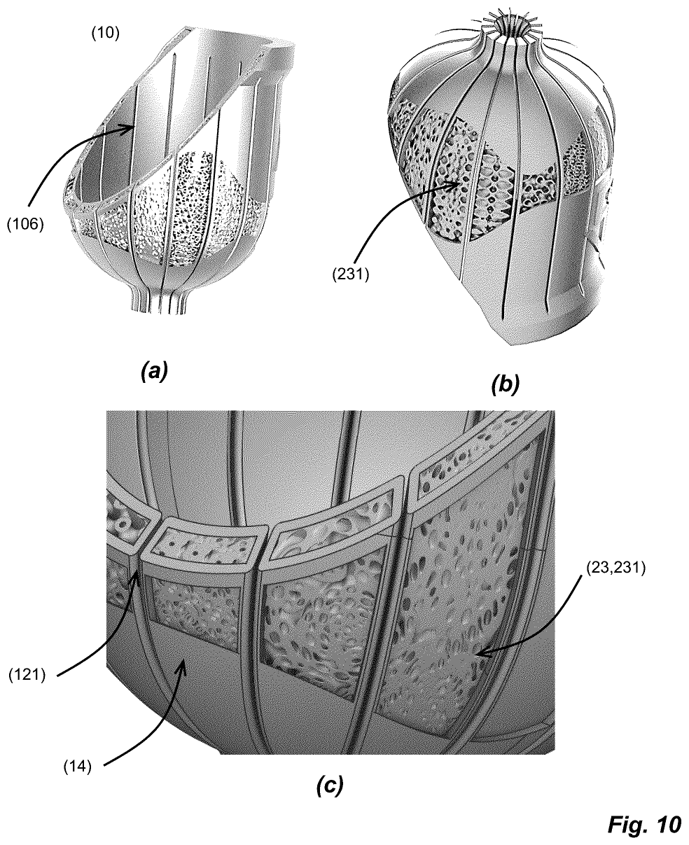

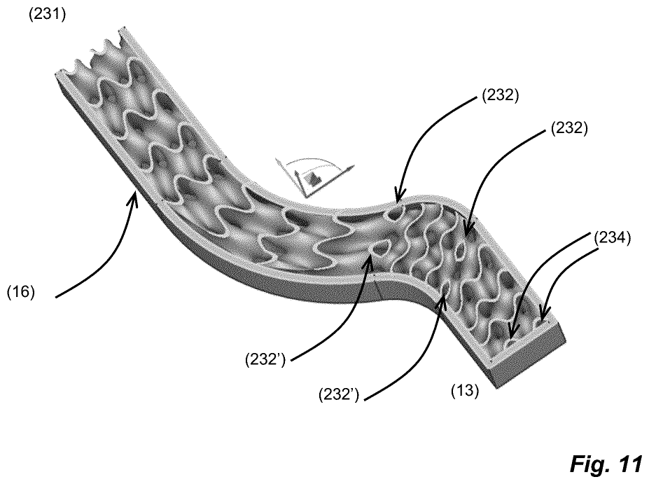

Advantageously, the plurality of gyroids (231) occupies the entire volume of the segments (14) as by the enclosed FIG. 10 and FIG. 11 show. Besides being self-supporting, gyroid structures (231) are also able to confer to the heat exchanger (23) rigidity and resistance to deformation.

As the enclosed FIG. 9(b) schematically depict, interconnected gyroids (231) form two domains: inlet paths (232), shown in dark grey, for the incoming fluid (i.e., entering the segment via delivery pipes (24)) and outlet paths (232′), shown in light grey, for the outcoming fluid (i.e., exiting the segment via return pipes (25)).

Taking advantage of the topological properties of gyroids, said domains forms two fluidically distinct domains (232,232′) for the coolant transport i.e., domains that do not intersect one to each. In order to create a closed hydraulic circuit, the domains or paths (232,232′) are fluidically connected at an end region (234).

Although more complicated than in the preferred embodiment, connections between inlet domain (232) and outlet domain (232′) can be obtained by means of AF technology.

In this way, the fluid incoming from the cooling circuit (not shown) can flow from the top of the body (10) to the bottom through the inlet paths (232) of the interconnected gyroids (231), then flow through the end region (234) and rise from the bottom of the body (10) to the top through the outlet paths (232) of the interconnected gyroids (231) and finally outcomes to the cooling circuit.

### Advantages and Industrial Application

From the description of the crucible according to the present invention, and the manufacturing process thereof, numerous advantages will appear evident to those skilled in the art.

As mentioned, the considerable increase in the levitation of the melt (40) represents the first and main technical effect. It is the consequence of mutually synergistic factors: first, the electromagnetically optimized goblet-like shape of the body (10); then the thin-walled segments (14); finally, a cooling system (20) with a heat exchanger (23) embedded into the segments (14). In turn, this effect determines the following advantages.

A first advantage is the reduction of the contamination of the melt (and therefore of the casted product), due to the fact that the crucible (1) is not subjected to corrosion and damage nor contains ceramic-refractory materials which may migrate to the melt (40).

A second advantage deriving from melt levitation enhancement is cut-cost of the crucible maintenance. In fact, the levitating melt (40) contacts the cold walls (16) of the crucible (1) only a short transitory time during the melting process. In this way a thin film of amorphous metal is produced which is easily removable from crucible since it does not adhere to the walls (16).

The third advantage of the crucible (1) according to the invention is the remarkable energy saving. Compared to a traditional cold crucible (with the same capacity), even 30-50% less energy is required for melting the metal and maintain in levitation the melt. This is a consequence of the electromagnetically optimized goblet-like shape of the crucible (1). In fact, it is possible to have extremely efficient transmission of power from the inductor (30) directly to the melt (40), or to the metal to be melted and levitated, with significantly lower resistive losses of the crucible (1) compared to traditional cold melting devices. This result can be achieved by selecting a combination of the following parameters: the geometry and number of segments (14), the thickness of the walls of the segments (without lowering, indeed improving, their cooling capacity), a material with high electrical and thermal conductivity for the crucible.

A fourth advantage of the present invention is the electromagnetic control capability of the melt compared to a traditional cold crucible. This is related to the shape and greater proximity of the inductor to the melt, especially near the discharge nozzle, which makes more efficient and economical to melt and manipulate the melt jet by properly selecting the radio frequencies applied to the second inductor.

Finally, a further advantage is due to the fact that the crucible according to the invention can be made using reliable Additive Manufacturing (AM) technologies by exploiting the use of metal powders of specific particle size, dispersion and shape. Furthermore, the use of AM technology allows to vary profile, number, twisting, positioning of the crucible slits and the appropriately rounded shape of the outflow nozzle of the molten jet, in order to adapt the levitation effect to the specific needs related e.g., to the metal or the melting metal alloy.

The advantages listed above are scalable in the sense that they are equally obtainable both in small capacity crucibles (volumes of a few cubic centimeters of melt) and in large capacity crucibles (several liters of melt). This allows, for example, extreme ease of miniaturization of the crucible for the melting of ultra-precious rare metals.

Thanks to these advantages, the crucible according to the present invention and the manufacturing process thereof, can be applied in various sectors.

In the jewelry market it is useful for investment casting of jewelry in precious and semiprecious metals such as palladium, platinum, gold and silver alloys, or in titanium/niobium alloys.

In the automotive or aerospace field, it can be advantageously used for the production of structural and non-titanium components and titanium alloys exposed to high temperatures such as titanium aluminide (TiAl) valves or turbine blades.

In the biomedical market, it is useful in a number of applications, for example the production of titanium prostheses. in the Oil & Gas market, for zirconium components for pumps and valves. Finally, in the leisure market, the present invention can be used for producing titanium (or other metal alloys) heads for golf clubs.

### CONCLUSIONS

To conclude, it has been found that the invention described hereinabove fully achieves the intended aim and objects.

In particular, thanks to a distributed cooling structure of the heat exchanger, crucibles with a greater number of slits and having the manifold of the cooling system positioned on the upper portion of the crucible can be advantageously obtained. In fact, a more efficient removal of heat from the crucible is possible thanks to the paths which are uniformly distributed and embedded even over the entire volume of the segment.

As mentioned previously mentioned, the distributed cooling structure allows at the same time to free space in the lower portion of the crucible thus uncoupling the cooling system from the geometry of the segments. In fact, from the description provided it shall be apparent to those skilled in the art as the hydraulic circuit that distributes the cooling liquid to the segments of the body can be advantageously housed in the upper portion of the crucible leaving freedom of design for segments and slits.

In addition, the distributed cooling structure allows to impart shapes to the crucible that are more transparent to electromagnetic radiation. In particular, this structure of the body allows the segments to be bent so as to bring them closer to the lower part. Furthermore, the network of paths of the cooling system can follow the inner concave region on the bottom of the body to maximize heat exchange. The result is a body having an inner concave region equipped with a nozzle which intensifies the heating of the melt, its levitation and manipulation.

Although the inventive concept underlying the present invention derives from the union of two distinct technology domains (i.e., cold crucibles technology and Additive Manufacturing), the novel cold crucible structure and the process of manufacturing thereof cannot be considered as an obvious juxtaposition of such domains. In fact, reduction to practice of the inventive concept has required a remarkable and non-trivial inventive effort as it shall be evident to those skilled in the art from the disclosure provided.

Particularly, the inventors had to overcome non-trivial technical problems for the skilled in the art, related to: curvature of the goblet-like crucible body, number of crucible segments, width of the segment walls, conformation of the embedded percolating paths.

Optimization of design parameters required advanced studies not available until now and the definition of a new design/manufacturing paradigm assisted by electromagnetic simulations of the melt-crucible-inductor-generator system.

To conclude, it is understood that the invention is not limited to the exemplary embodiments shown and described herein and although the description and examples provided contain many details, these should not be construed as limiting the scope of the invention but simply as illustrative illustrations of some embodiments of the present invention.

Hence, any modification of the present invention which falls within the scope of the following claims is considered to be part of the present invention.

Where the characteristics and techniques mentioned in any claim are followed by reference signs, these reference marks have been applied solely for the purpose of increasing the intelligibility of the claims and consequently these reference marks have no limiting effect on the interpretation of each element identified by way of example from these reference signs.

1. A cold crucible (1) for melting metal materials, the crucible comprising:
a metal body (10) having walls (16) defining an internal volume (106) inside which a material (40) is received, wherein said walls (16) are divided into segments (15) by a plurality of slits (121);
an induction coil (30) wound around said body (10) and configured so as to melt said material (40);
a cooling system (20) for said body (10) configured to maintain a circulation of a fluid between one or more fluid inlets (21) and one or more fluid outlets (22),
said cooling system (20) comprising a heat exchanger (23) integrated within a volume of said segments (15), wherein said heat exchanger (23) consists of a plurality of interconnected structures (231) which are fluidically connected to each other and are fluidically connected to said one or more fluid inlets (21) and to said one or more fluid outlets (22), so that said fluid can circulate inside the heat exchanger (23) along one or more paths (232) which extend between said one or more fluid inlets (21) and said one or more fluid outlets (22), with a net mass flow between said one or more fluid inlets (21) and said one or more fluid outlets (22), and wherein said heat exchanger (23) is obtained by means of an additive manufacturing technique.

2. The crucible (1) according to claim 1 wherein said body (10) or said induction coil (30) are obtained by means of an additive manufacturing technique.

3. The crucible (1) according to claim 1 wherein said body (10) is cylindrically symmetric and has a cylindrical or a goblet-like shape.

4. The crucible (1) according to claim 1, wherein said walls (16) have a thickness of less than 20%, with respect to the greater diameter of the body (10) of said crucible (1).

5. The crucible (1) according to claim 1, wherein said walls (16) are curved or at least partially curved.

6. The crucible (1) according to claim 1, wherein said one or more fluid inlets (21) and said one or more fluid outlets (22) are positioned in the upper portion (11) of said body (10).

7. The crucible (1) according to claim 1, wherein the number of segments (15) is between 4 and 20.

8. The crucible (1) according to claim 1, wherein said slits (121) are of the type selected from the group consisting of: slit with parallel faces, slit with converging faces, slit with rotated parallel faces, radial slit, inclined slit, and combinations thereof.

9. The crucible (1) according to claim 1, wherein said structures (231) are selected from the group consisting of: pipes with constant or variable section, gyroids, catenoids, helicoids, Schwarz surfaces, Neovius surfaces, double domain sponge structures, minimal surface structures, and combinations thereof.

10. The crucible (1) according to claim 1, wherein:
said structures (231) are units of curved or straight tubular pipes, having constant section;
said structures (231), once fluidically interconnected one to each other, form one or more delivery pipes (24) and one or more return pipes (25) which are fluidically connected by connecting pipes (26), said pipes (25,25,26) being embedded within said segments (14) to form a distributed heat exchanger (23), wherein said fluid can flow from top of the body (10) to bottom through substantially straight delivery pipes (24), then flow through curved connecting pipes (26) and finally rise from the bottom of the body (10) to the top through substantially straight return pipes.

11. The crucible (1) according to claim 1, wherein:
said structures (231) are gyroids; and
said structures (231), once fluidically interconnected one to each other, form inlet paths (232) and outlet paths (232′), wherein said paths (232,232′) are two fluidically distinct domains connected at an end region (234), said paths (232,232′) and end region (234) being embedded within said segments (14) to occupy substantially the entire volume of segments (14) and form a distributed heat exchanger (23), wherein said fluid can flow from the top of the body (10) to the bottom through the inlet paths (232) of the interconnected gyroids (231), then flow through the end region (234), and finally rise from the bottom of the body (10) to the top through the outlet paths (232) of the interconnected gyroids (231).

12. The crucible (1) according to claim 1, wherein said induction coil (30) has a shape following the geometry of said body (10), said shape having an asymmetrical section consisting of an outer rounded part and an inner flattened part facing the crucible body (10).

13. The crucible (1) according to claim 1, wherein said metal is selected from the group consisting of: copper, gold, platinum, rhodium, palladium, silver, ultra-precious metals, refractory alloys, non-refractory alloys, metals and alloys with melting above about 1500° C., and combinations thereof.

14. The crucible (1) according to claim 1, wherein the crucible has a melting capacity greater than 25%, with respect to a traditional crucible having the same energy consumption.

15. The crucible (1) according to claim 1, wherein the crucible has an energy consumption 50% to 100% less than a known cold crucibles having the same capacity.

16. The crucible (1) according to claim 1, wherein said additive manufacturing technique is selected from the group consisting of: Selective Laser Melting (SLM), Direct Metal Laser Sintering (DMLS), Binder Jetting (BJ), and combinations thereof.

17. The crucible (1) according to claim 1, further comprising a pouring nozzle (132) positioned on a bottom portion of said body (10) for pouring said material (40) when it is melted, said pouring nozzle (132) which can be switched between an opened state and a closed state by applying a signal by means of a second induction coil (133).

18. Process for manufacturing the crucible according to claim 1, the method comprising:
a) defining a digital model of the crucible (1), particularly of the heat exchanger (23), by operating simulations to optimize one or more parameters including: the capacity of the crucible (1), the melting point of the material (40), the levitation force acting on the material (40), the maximum intensity of the induction field on the basis of the characteristics of the induction coil (30) and of the applied current, the stability of the position of the melt;
b) loading said digital model on an Additive Manufacturing machine and selecting a suitable material with high electrical and thermal conductivity for producing said crucible, said material being in powder form;
c) by means of the additive manufacturing technique chosen in the previous step b), manufacturing of one or more components of said crucible (1) selected from: the body (10), the cooling system (20), or the induction coil (30);
d) optionally, finish said one or more components (10,20,30) manufactured in the previous step c).

19. The process for manufacturing the crucible according to claim 18 wherein said body (10) and induction coil (30) are made as distinct parts to be assembled at a later time or, alternatively, are made at the same time by means of an additive manufacturing technique.

20. Process for manipulating a casting of a melt comprising.
a) obtaining a crucible (1) according to claim 1;
b) by means of said crucible (1) melting a material (40) so as to obtain a melted material (40);
c) programming a first signal, to be applied to said second inductor (133) so as to cause said pouring nozzle (132) to be switched from a closed state to an opened state and discharge a desired amount of melt at a given time;
d) optionally, applying a second signal to said second inductor (133) so as to cause said pouring nozzle (132) to be switched from an opened state to a closed state.

21. Process for melting metals and metal alloys by means of a cold crucible according to claim 1, wherein energy consumption is 50% to 100% less than the energy required in a melting process implemented by means of known cold crucibles having the same capacity.
